(19) United States
(12) Patent Application Publication
(10) Pub. No.: US 2017/0054202 A1
(43) Pub. Date: Feb. 23, 2017

(54) ANTENNA

(71) Applicant: LEONARDO MW LTD, Basildon Essex (GB)

(72) Inventors: David ATKINS, Basildon Essex (GB); David HALL, Basildon Essex (GB); Stephen COLE, Basildon Essex (GB)

(73) Assignee: Leonardo MW Ltd, Basildon Essex (GB)

(21) Appl. No.: 15/308,322

(22) PCT Filed: May 1, 2015
(86) PCT No.: PCT/EP2015/059618

§ 371 Date: Nov. 1, 2016

(30) Foreign Application Priority Data
May 1, 2014 (GB) 1407733.3

(51) Int. Cl. H01Q 1/32; H01Q 1/38; H01Q 15/00

(52) U.S. Cl. CPC H01Q 1/325; H01Q 15/0086; H01Q 1/38

(57) ABSTRACT

An antenna is disclosed in which the radiating structure includes a meta-material having frequency selective properties. The frequency selective properties of the meta-material enable multiple antennas each designed for operation at separate frequencies and each having such meta-materials to be placed in close proximity without affecting each other. This can be advantageous if for example a large number of antennas are to be placed in a small area such as on a vehicle or small building.

The invention relates to antenna. More specifically but not exclusively, it relates to an antenna and a method of constructing an antenna to enable multiple antennas to be placed in close proximity.

Conventional monopole and dipole antennas are formed from conductors, typically copper or aluminium, that carry the conduction currents that give rise to electromagnetic radiation, which couples into the surrounding space and propagates away from the antenna.

The dimensions of the antenna are set to match the frequency requirements of the system or radio connected to it; typically monopole antennas will be optimised at a ¼-wavelength and dipoles will be optimised at a ½-wavelength. These optimum lengths ensure that the direction of maximum radiation intensity is broadside to the antenna aspect; this ensures that the radiated power is directed away from the antenna in a controlled and efficient manner to maximise the radio propagation range and system performance.

If the antenna length is very much longer than the design optimum, the radiation pattern will distort and maximum radiation intensity might not be broadside and therefore the radio link and system performance may be degraded. In the extreme, if the antenna length is 1-wavelength or multiple thereof, theoretically there will be no radiation in the broadside plane. Likewise if an optimised antenna is placed in very close proximity to an adjacent antenna of non-optimum length, energy from the primary antenna will parasitically couple into the second antenna and the resultant radiation characteristics will be a summation of the direct antenna pattern plus the parasitic antenna pattern which will not be optimum.

Whilst the use of in-line antenna filters is effective in terms of protecting adjacent radios connected to close-located antenna elements, it is not effective in reducing the currents induced on the adjacent close-located antennas from re-radiating and corrupting the radiation patterns of the direct fed antenna.

That is, effectively there are 2 problems with close-spaced antennas and the high levels of coupling that result:

Firstly, high amounts of radio power are coupled into the adjacent antenna(s) and adversely impact on the radio(s) connected to them.

Secondly, currents coupled onto adjacent antenna(s) are re-radiated and corrupt the radiation pattern of the principle antenna element. While current in-line filter technology can overcome the first issue it does not address this second issue.

According to the invention there is provided an antenna comprising a primary radiating structure, the primary structure comprising a meta-material having frequency selective properties, the meta-material having a predetermined frequency of operation, such that the antenna transmits and receives at the predetermined frequency only, the meta-material impeding current flow in the structure at all other frequencies.

According to the invention there is further provided a plurality of antenna, each antenna comprising a primary radiating structure, each primary structure comprising a meta-material having frequency selective properties, each antenna having a predetermined frequency of operation, such that each antenna transmits (and receives?) at the predetermined frequency only, the meta-material impeding current flow in the structures at all other frequencies, thereby enabling the individual antenna to operate in close proximity to each other without interference.

In this way, the invention overcomes the problems described above with reference to prior art systems.

The invention will now be described with reference to the following drawings in which:

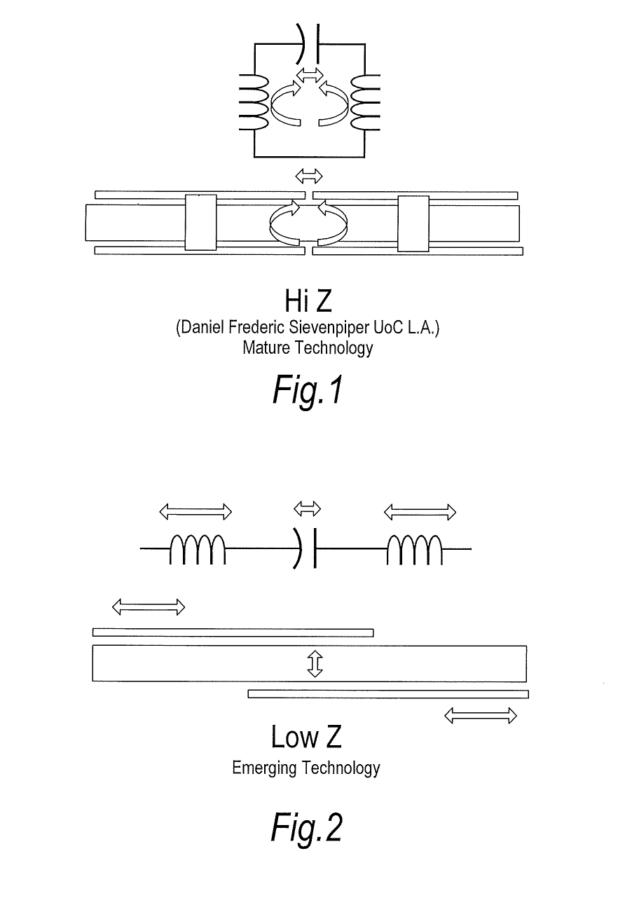

FIG. 1 is a schematic drawing of a prior art “high z” meta-material;

FIG. 2 is a schematic drawing of a prior art “low z” meta-material;

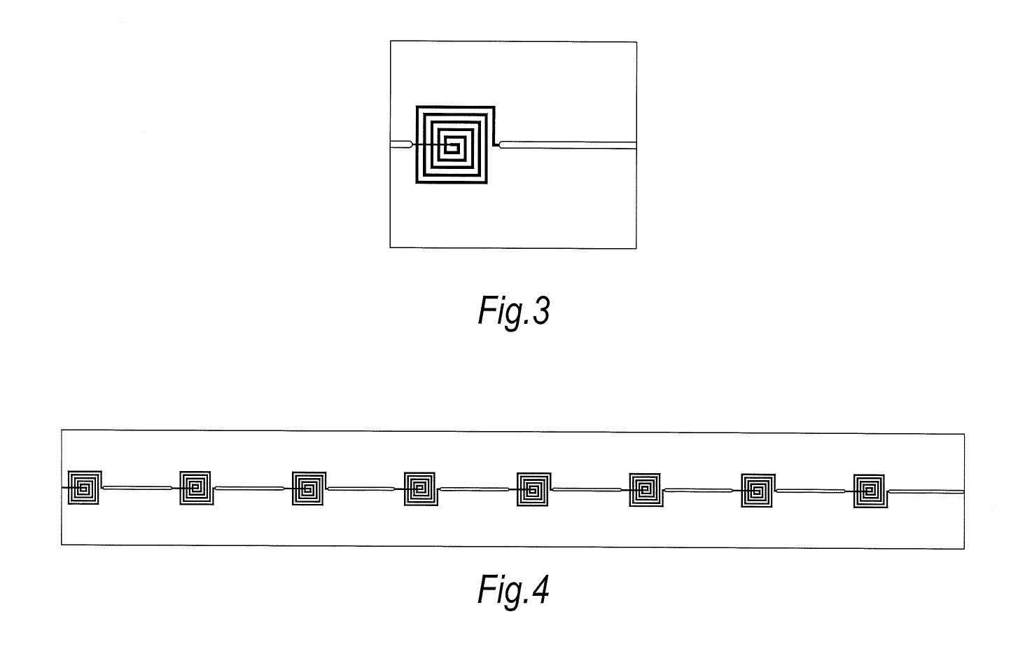

FIG. 3 is a schematic drawing of one design of meta-material cell in accordance with one form the invention;

FIG. 4 is a schematic drawing of one design of antenna formed from a series of meta-material cells of FIG. 3 in accordance with one form of the invention;

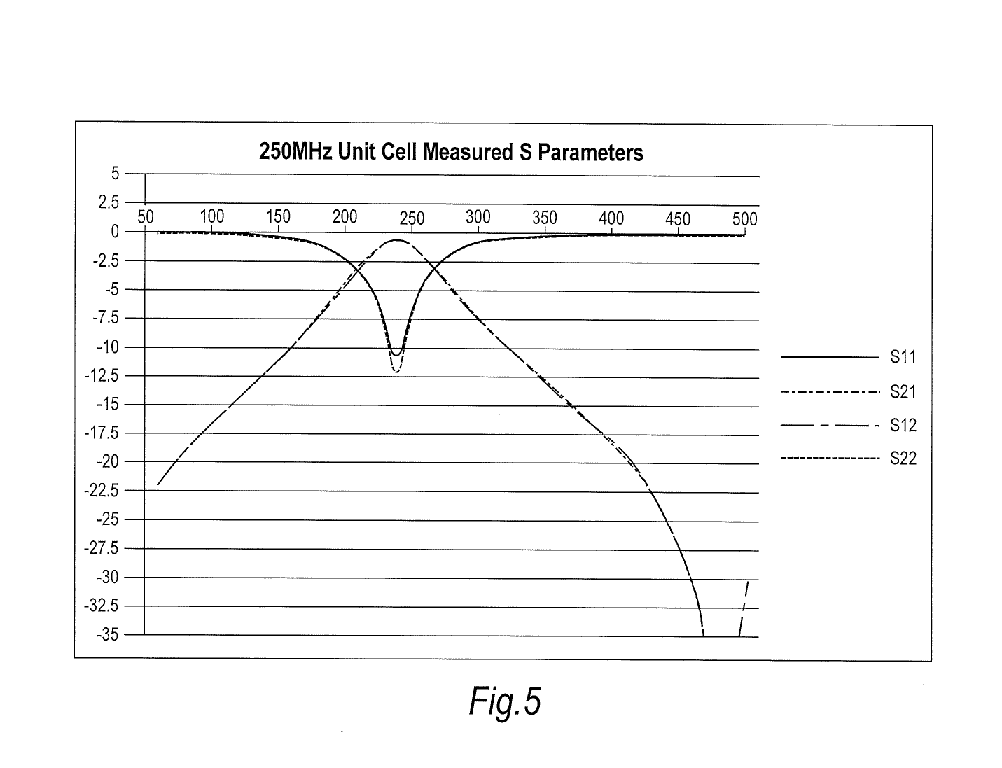

FIG. 5 is a graph of the swept frequency transmission characteristics of the meta-material design of FIG. 3.

Meta-materials are artificial materials engineered to have properties that may not be found in nature. They are assemblies of multiple individual elements fashioned from conventional materials such as metals or plastics, but the materials are usually arranged in repeating patterns. Meta-materials gain their properties not from their composition, but from their exactingly-designed structures. Their precise shape, geometry, size, orientation and arrangement can affect all forms of electromagnetic radiation (including but not limited to light and radio waves) in an unconventional manner, creating material properties which are unachievable with conventional materials. These meta-materials achieve desired effects by incorporating structural elements of sub-wavelength sizes, i.e. features that are actually smaller than the wavelength of the waves they affect.

The meta-material used in the invention is a low impedance frequency selective surface and is analogous to an array of series tuned circuits; that will conduct current at a predetermined resonant design frequency and impede current flow at other frequencies. The meta-material is formed from an array of multiple unit cells which permit surface current flow over only a narrow band of frequencies. A typical unit cell in accordance with one form of the invention is shown in FIG. 3.

An antenna or radiating element is constructed from a series of meta-material cells that have frequency selective properties, i.e. the antenna will only conduct current at the range of frequencies over which the antenna is designed for operation. This differs from metallic conductors that have virtually frequency agnostic conductive properties.

In one example, this has been achieved using a printed circuit form although it will be appreciated that any suitable meta-material or structure exhibiting similar properties can be utilised. For example a meta-material comprising copper and Kapton™ has been used in the examples and embodiments used below. However, it will be appreciated that any suitable combination of conductive and non-conductive materials formed as a suitable meta-material may be used.

Antennas constructed using this meta-material are formed from an array of cells, as shown in FIG. 4 laid out in such a way as to duplicate the physical form of the traditional metallic antenna being implemented, typical examples would be, in the case of a monopole or dipole, a linear structure or in the case of a loop antenna a shape approximating a circular structure. The swept frequency transmission characteristics shown in FIG. 5. This is an image of part of a strip of meta-material used to create a 100 MHz antenna in accordance with the invention. Alternate cells are conductive tracks on alternate sides of the PCB used to fabricate this material.

The cells are designed such that at the design frequency of the antenna, the end-to-end impedance is low, and at all other frequencies the end to end impedance is high. Although a single strip of cells is represented here, the material can be produced with an array or pattern of cells, and the cells themselves can be many different shapes.

In one form of the invention, for example only, consider the case of two dipole antennas A and B, where antenna A is designed to operate at a frequency of f and antenna B is designed to operate at a frequency at half the frequency (f/2). Using conventional construction materials and techniques the two antennas would strongly interact if located in close proximity to each other.

Utilising the construction techniques outlined above, antenna A would be made from a frequency selective meta-material conductive at frequency A only, and antenna B would be made from a frequency selective meta-material conductive only at frequency B. In this instance antenna A would be transparent at frequency B and antenna B would be transparent at frequency A. Due to this property the antennas will not affect the radiation patterns or performance of each other nor will significant energy be coupled from the antenna outside of its design frequency to the attached equipment

The performance of an antenna constructed of such meta-material can exhibit performance comparable to the traditional antenna at the predetermined design frequencies. Moreover, the antenna gain is comparable to a traditional antenna at the predetermined design frequencies.

In this way, a plurality of antennas can be positioned on a single structure or vehicle with the minimum of interaction or coupling. As can be seen in FIG. 5, the s-parameter plot shows how the unit cell of FIG. 3 has good transmission characteristics at a nominal design frequency, and impedes current flow either side of this point. By appropriately arranging these unit cells, a conducting shape can be formed that radiates well as an antenna at the design frequency but does not radiate nor support surface currents at other frequencies, thus allowing antennas utilising differently tuned meta-material to be positioned in close proximity without interaction.

Utilising differently tuned shapes of this meta-material it is possible to produce a set of antennas with advantages over conventional techniques as summarised below.

In one example, antenna A would be made from a frequency selective meta-material conductive at 100 MHz and antenna B would be made from a frequency selective meta-material conductive at a frequency of 50 MHz.

In a second example, antennas according to the invention above having frequency selective meta-material structures conductive at 100 MHz, 230 MHz, 420 MHz, and 500 MHz have been used in close proximity with no appreciable interference.

It will be appreciated that the number of antenna is not limited to two or four but any number of antenna subject to the meta-materials structures being used, being capable of producing the required number of antenna made from frequency selective meta materials conductive at discrete predetermined frequencies.

1. An antenna comprising:
a primary radiating structure, the primary structure including a meta-material having frequency selective properties, the meta-material having a predetermined frequency of operation, such that the antenna will transmit and receive at the predetermined frequency only, the meta-material impeding current flow in the structure at all other frequencies.

2. The antenna according claim 1, included in a combination within a series of antennae wherein the series of antenna comprises:
a plurality of antenna mounted immediately adjacent each other, each individual antenna having a different predetermined frequency of operation, thereby ensuring that transmitted and received signals from the plural antennae do not interfere with one another.

3. An antenna according to claim 1 in which the meta-material comprises:
a combination of conductive and non-conductive materials.

4. An antenna according to claim 3 in which the conductive material is metallic and the non-conductive material is non-metallic.

5. An antenna according to claim 4 in which the metallic material is copper and the non-conductive material is a printed circuit board substrate.

6. An antenna according to claim 1 in which the predetermined frequency is 50 MHz, 100 MHz, 230 MHz, 420 MHz, or 500 MHz.

7. An antenna according to claim 1 in which the antenna is mounted on a vehicle or other platform.

8. An antenna according to claim 4 in which the metallic material is copper and the non-conductive material is Kapton.

9. An antenna according to claim 2 included in a combination within a series of antennae wherein the meta-material comprises:
a combination of conductive and non-conductive materials.

10. An antenna according to claim 9 included in a combination within a series of antennae wherein the conductive material is metallic and the non-conductive material is non-metallic.

11. An antenna according to claim 10 included in a combination within a series of antennae wherein the metallic material is copper and the non-conductive material is a printed circuit board substrate.

12. An antenna or series of antenna according to claim 11 included in a combination within a series of antennae wherein predetermined frequencies are 50 MHz, 100 MHz, 230 MHz, 420 MHz, or 500 MHz

13. An antenna according to claim 12 included in a combination within a series of antennae wherein the series of antenna are mounted on a vehicle or other platform.

14. An antenna according to claim 13 in which the metallic material is copper and the non-conductive material is Kapton.
